(19) United States
(12) Patent Application Publication
(10) Pub. No.: US 2012/0034498 A1
(43) Pub. Date: Feb. 9, 2012

(54) FUEL CELL, PLATE HAVING THROUGH-PLANE CONDUCTIVITY, AND MANUFACTURING METHOD THEREOF

(75) Inventors: FU-MING HSU, Taipei County (TW); JEN-HAO CHEN, Hsinchu City (TW)

(73) Assignee: NATIONAL CHIAO TUNG UNIVERSITY, Hsinchu City (TW)

(21) Appl. No.: 12/950,125

(22) Filed: Nov. 19, 2010

(30) Foreign Application Priority Data
Aug. 6, 2010 (TW) 099126386

(51) Int. Cl. H01M 4/80; B05D 5/12

(52) U.S. Cl. 429/10; 427/115

(57) ABSTRACT

A fuel cell, a plate having through-plane conductivity and a manufacturing method of the plate are disclosed. The plate having through-plane conductivity includes a substrate and a plurality of linear conductors. The linear conductors are respectively coated with a metal material, and are oriented by a magnetic field to arrange in the substrate with an extending direction perpendicular to a plane surface of the substrate. The substrate is made of an epoxy resin material, the linear conductors are carbon fibers, and the metal material is a magnetic material, such as iron, cobalt or nickel. The fuel cell includes bipolar plates that are respectively made of the above-described plate having through-plane conductivity.

### FIELD OF THE INVENTION

The present invention relates to a fuel cell, a plate having through-plane conductivity, and a manufacturing method of the plate; and more particularly to a plate having linear conductors arranged therein and extended in a direction perpendicular to a plane surface of the plate, a manufacturing method of the plate, and a fuel cell including bipolar plates made of such plates.

### BACKGROUND OF THE INVENTION

With the gradually expanded fuel cell application market, a key component of the fuel cell, namely, the bipolar plate, has received gradually increased attention among the fuel cell field. The bipolar plate is also referred to as a flow field plate, a bipolar electrode, a current collector, a delivery plate or an internal connector, and is a basic structure for the fuel cell to operate. The bipolar plates in the fuel cell carry fuel and air into their corresponding electrode to ensure the air and the fuel are completely separated from each other. The bipolar plates provide a mechanical support and necessary strength to the membrane electrode assembly (MEA), enable required seal strength in delivering air and fuel, incorporate manifolds thereinto, and assist in adjustment of fuel cell stack temperature. The manifold functions like a windpipe in the human respiratory system to send gas into channels, which function like a man's bronchia, formed on the bipolar plate. Finally, the gas flows through gas diffusion layers to finely and uniformly distribute in catalytic layers.

The bipolar plates are the most important factor that determines the weight power density and the volumetric power density of the fuel cell. In a typically designed fuel cell, when the end plates are excluded, the bipolar plates account for more than 80% of an overall weight of the fuel cell stack, and account for almost the entire volume of the fuel cell stack. Natural graphite is one form of pure carbon having a melting point as high as 4500° C., which is the highest one among the currently available solid-state materials, and has the best stability compared to other solid materials. As to synthetic graphite, it is a carbon-carbon composite material, initially developed for aerospace industry, and has now been widely used in making rocket nozzles and airplane brake disks. Due to its high strength, good conductivity and chemical stability, the synthetic graphite is the earliest material that is used to make the bipolar plates for fuel cells.

However, in the conventional bipolar plates, the carbon fibers added thereinto are not oriented. That is, the carbon fibers are disorderly distributed in the bipolar plates, resulting in poor through-plane conductivity of the bipolar plates. Under this circumstance, the fuel cell efficiency is apparently lowered particularly when a high current density is applied thereto.

### SUMMARY OF THE INVENTION

A primary object of the present invention is to provide a fuel cell, a plate having through-plane conductivity, and a manufacturing method of the plate, so as to overcome the problem of low efficiency of conventional fuel cells that do not include bipolar plates having oriented linear conductors.

To achieve the above and other objects, the plate having through-plane conductivity according to the present invention includes a substrate and a plurality of linear conductors arranged in the substrate. The linear conductors are oriented by a magnetic field to have an extending direction perpendicular to a plane surface of the substrate, and are respectively coasted with a metal material.

In the present invention, the linear conductors are carbon fibers.

In the present invention, the substrate is made of an epoxy resin material.

In the present invention, the metal material is a magnetic material, such as iron, cobalt, or nickel.

To achieve the above and other objects, the manufacturing method of the plate having through-plane conductivity includes the steps of coating each of a plurality of linear conductors with a metal material; mixing the linear conductors with a substrate material; injecting the mixture of the substrate material and the linear conductors into a mould for injection molding a plate; and applying a magnetic field to the mixture in the mould, so that the linear conductors in the substrate material are oriented to extend in a direction perpendicular to a plane surface of the molded plate.

In the manufacturing method of the present invention, the linear conductors are carbon fibers.

In the manufacturing method of the present invention, the substrate is made of an epoxy resin material.

In the manufacturing method of the present invention, the metal material is a magnetic material, such as iron, cobalt, or nickel.

To achieve the above and other objects, the fuel cell according to the present invention includes a first end plate; a first current collector arranged on the first end plate; a first conductive carbon paper arranged on the first current collector; a first bipolar plate arranged on the first conductive carbon paper; a membrane electrode arranged on the first bipolar plate; a second bipolar plate arranged on the membrane electrode; a second conductive carbon paper arranged on the second bipolar plate; a second current collector arranged on the second bipolar plate; and a second end plate arranged on the second current collector. The first bipolar plate includes a first substrate and a plurality of linear conductors arranged in the first substrate and oriented by a magnetic field to extend in a direction perpendicular to a plane surface of the first substrate; and the linear conductors are respectively coated with a metal material.

In the fuel cell of the present invention, the second bipolar plate includes a second substrate and a plurality of linear conductors arranged in the second substrate and oriented by a magnetic field to extend in a direction perpendicular to a plane surface of the second substrate; and the linear conductors are respectively coated with a metal material.

In the fuel cell of the present invention, the linear conductors are carbon fibers.

In the fuel cell of the present invention, the substrate is made of an epoxy resin material.

In the fuel cell of the present invention, the metal material is a magnetic material, such as iron, cobalt, or nickel.

In the fuel cell of the present invention, one of the first and the second substrate is provided on one surface facing toward the membrane electrode with a gas channel.

In the present invention, by providing oriented linear conductors in the bipolar plate manufactured with the method of the present invention, the bipolar plate and the fuel cell using such bipolar plate can have upgraded through-plane conductivity to thereby effectively overcome the problem of poor efficiency in the conventional fuel cells.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a flowchart showing the steps of manufacturing a plate having through-plane conductivity according to the present invention;

FIG. 2 is a schematic view of a plate having through-plane conductivity according to the present invention;

FIG. 3 is an image of an embodiment of the plate having through-plane conductivity according to the present invention; and

FIG. 4 is an exploded perspective view of a fuel cell according to the present invention.

### DETAILED DESCRIPTION OF THE PREFERRED EMBODIMENTS

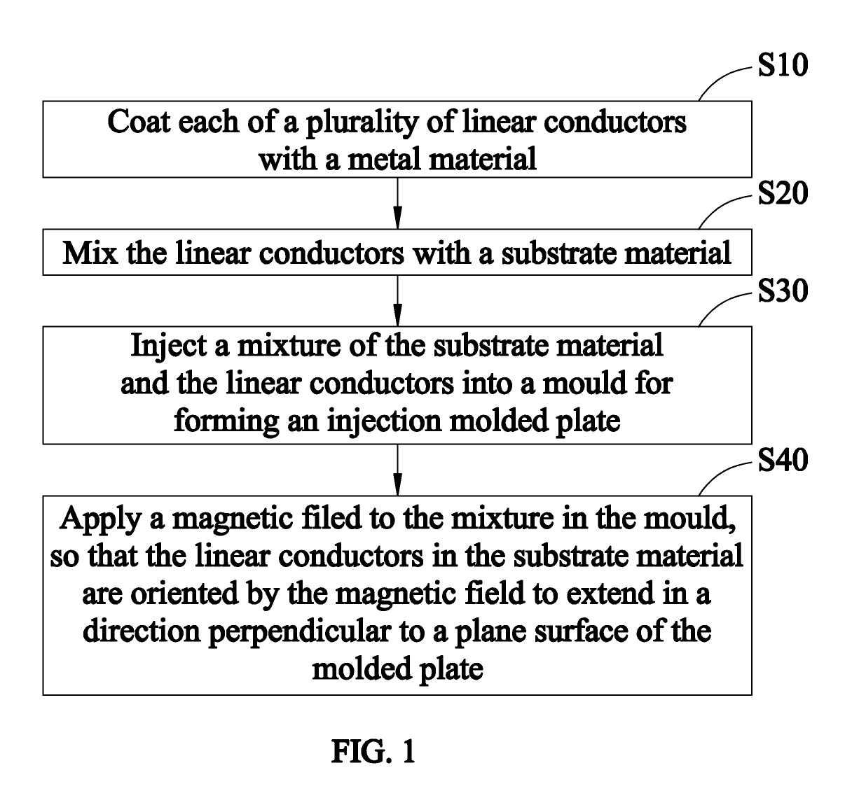

Please refer to FIG. 1 that is a flowchart showing the steps included in a method of manufacturing a plate having through-plane conductivity. As shown, the manufacturing method includes the following steps: coating each of a plurality of linear conductors with a metal material (S10); mixing the linear conductors with a substrate material (S20); injecting the mixture of the substrate material and the linear conductors into a mould for injection molding a plate (S30); and applying a magnetic field to the mixture in the mould, so that the linear conductors in the substrate material are oriented to extend in a direction perpendicular to a plane surface of the molded plate (S40).

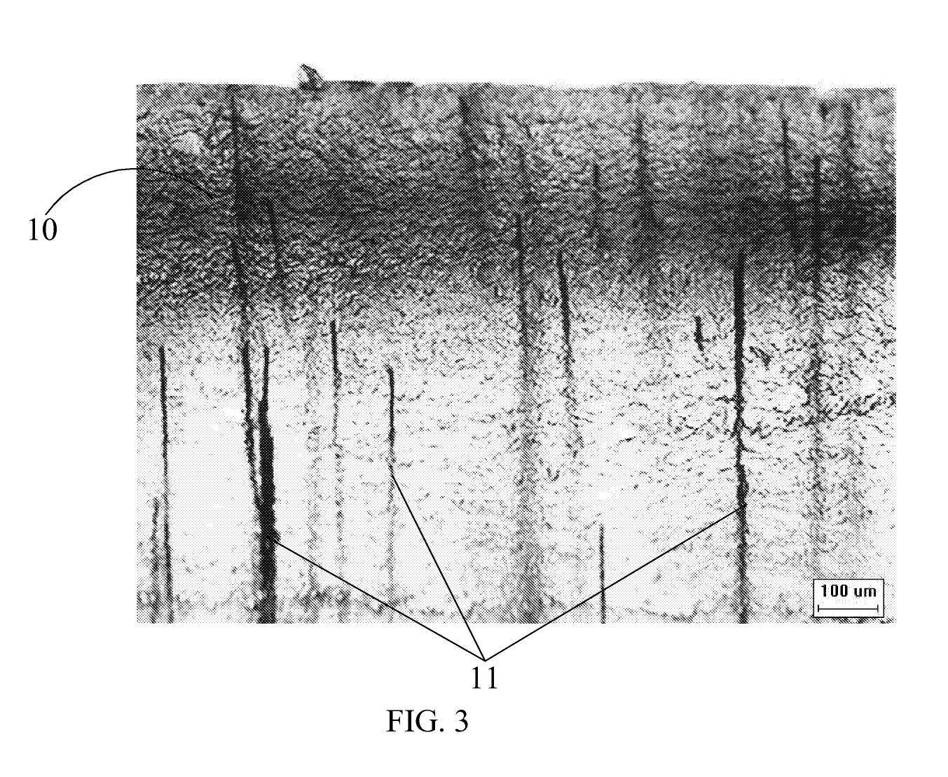

In some preferred embodiments of the present invention, the linear conductors preferably have a length about 1 mm, and a diameter about 10 μm. The metal material for coating the linear conductors can be nickel. The substrate material is preferably a two-component epoxy resin material including a component A and a component B, which have a viscosity of 850 cps and 60 cps, respectively, and are mixed at a ratio of 3:1. The linear conductors and the epoxy resin material for the substrate are mixed and stirred for 30 minutes, and the mixture is then injected into a desired mould. The field fringing effect is ignored and a maximum magnetic field density of 0.069 Tesla is applied to the mixture in the mould for 30 minutes. The mould is opened after 12 hours and the finished product is removed from the mould. FIG. 3 is an image showing oriented linear conductors are distributed in the injection molded plate manufactured using the method of the present invention.

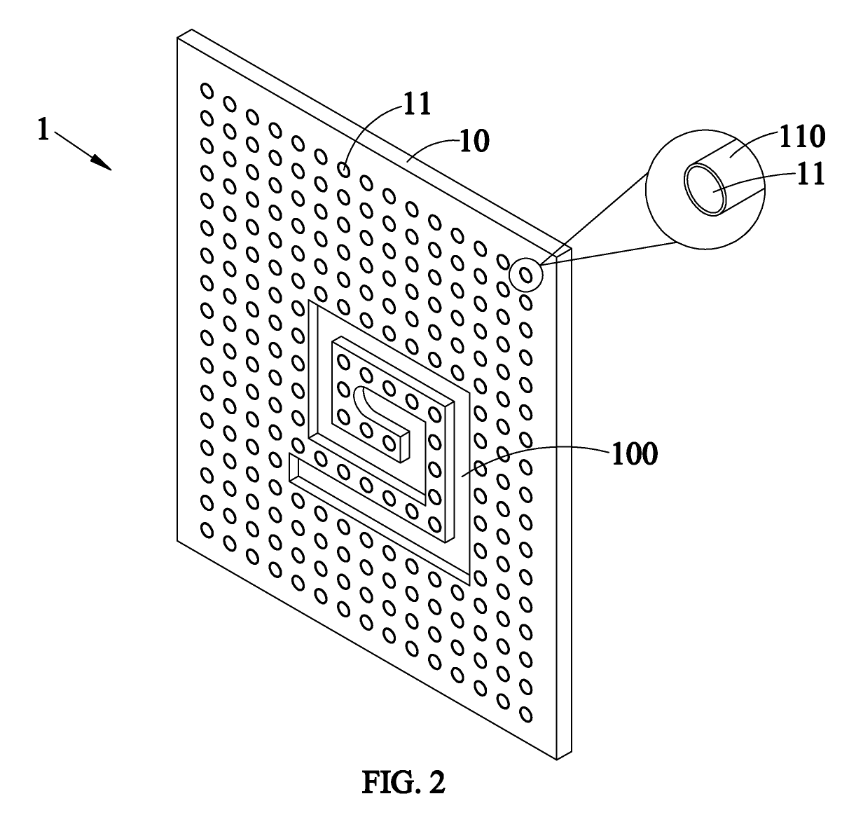

Please refer to FIG. 2 that schematically shows a plate having through-plane conductivity according to the present invention, which is generally denoted by reference numeral 1 and is also briefly referred to as the plate herein. As shown, the plate 1 includes a substrate 10 and a plurality of linear conductors 11. The linear conductors 11 are oriented by a magnetic field to arrange in the substrate 10 with an extending direction perpendicular to a plane surface of the substrate 10. Further, each of the linear conductors 11 is coated with a metal material 110. In some preferred embodiments, the metal material 110 can be a magnetic material, such as iron, cobalt or nickel; and the substrate 10 can be made of an epoxy resin material.

Please refer to FIG. 3 that is an image of an embodiment of the plate having through-plane conductivity according to the present invention. As shown, the linear conductors 11 extend through the substrate 10 in a thickness direction thereof and are in the form of straight lines perpendicular to the plane surface of the substrate 10. With these linear conductors 11 arranged in the substrate 10 and extended in a direction perpendicular to the plane surface of the substrate 10, the plate 1 can have largely increased electric conductivity in the extending direction of the linear conductors 11.

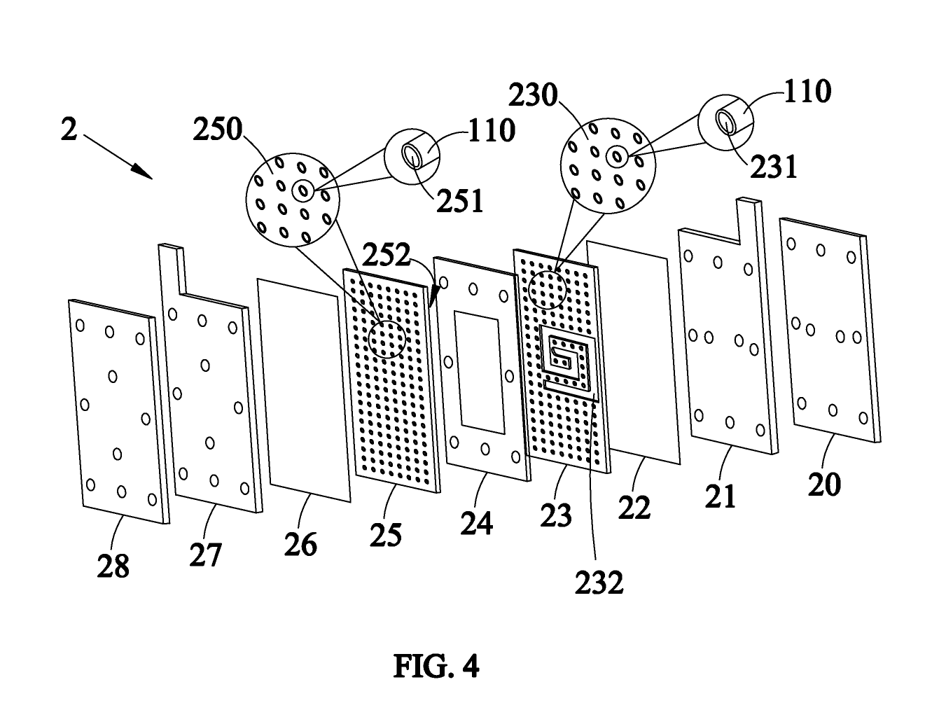

FIG. 4 is an exploded perspective view of a fuel cell 2 according to the present invention. As shown, the fuel cell 2 includes a first end plate 20, a first current collector 21, a first conductive carbon paper 22, a first bipolar plate 23, a membrane electrode 24, a second bipolar plate 25, a second conductive carbon paper 26, a second current collector 27, and a second end plate 28. The first current collector 21 is arranged on the first end plate 20, the first conductive carbon paper 22 is arranged on the first current collector 21, the first bipolar plate 23 is arranged on the first conductive carbon paper 22, the membrane electrode 24 is arranged on the first bipolar plate 23, the second bipolar plate 25 is arranged on the membrane electrode 24, the second conductive carbon paper 26 is arranged on the second bipolar plate 25, the second current collector 27 is arranged on the second conductive carbon paper 26, and the second end plate 28 is arranged on the second current collector 27. The first bipolar plate 23 includes a first substrate 230 and a plurality of linear conductors 231. The linear conductors 231 are oriented by a magnetic field to arrange in the first substrate 230 in an extending direction perpendicular to a plane surface of the first substrate 230. And, each of the linear conductors 231 is coated with a metal material 110.

Similarly, the second bipolar plate 25 includes a second substrate 250 and a plurality of linear conductors 251. The linear conductors 251 are oriented by a magnetic field to arrange in the second substrate 250 in an extending direction perpendicular to a plane surface of the second substrate 250. And, each of the linear conductors 251 is coated with a metal material 110. In the present invention, the first substrate 230 and the second substrate 250 can be made of an epoxy resin material, and the metal material 110 can be a magnetic material, such as iron, cobalt, or nickel. Further, the first substrate 230 or the second substrate 250 is provided on one surface facing toward the membrane electrode 24 with a gas channel 232 or 252 to assist in the flowing of gases and the occurrence of reaction between the gases in the fuel cell 2.

In the present invention, due to the oriented linear conductors, such as carbon fibers, in the bipolar plate manufactured with the method of the present invention, the bipolar plate and the fuel cell using such bipolar plate can have upgraded through-plane conductivity to thereby effectively overcome the problem of poor efficiency in the conventional fuel cells.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A plate having through-plane conductivity, comprising:
a substrate; and
a plurality of linear conductors being oriented by a magnetic field to arrange in the substrate in an extending direction perpendicular to a plane surface of the substrate;
wherein the linear conductors are respectively coated with a metal material.

2. The plate having through-plane conductivity as claimed in claim 1, wherein the substrate is made of an epoxy resin material.

3. The plate having through-plane conductivity as claimed in claim 1, wherein the linear conductors are carbon fibers.

4. The plate having through-plane conductivity as claimed in claim 1, wherein the metal material is a magnetic material selected from the group consisting of iron, cobalt, and nickel.

5. A method of manufacturing plate having through-plane conductivity, comprising the following steps:
coating each of a plurality of linear conductors with a metal material;
mixing the plural linear conductors with a substrate material;
injecting the mixture of the substrate material and the plural linear conductors into a mould for injection molding a plate; and
applying a magnetic field to the mixture in the mould, so that the plural linear conductors in the substrate material are oriented by the magnetic field to extend in a direction perpendicular to a plane surface of the plate.

6. The method of manufacturing plate having through-plane conductivity as claimed in claim 5, wherein the substrate material is an epoxy resin material.

7. The method of manufacturing plate having through-plane conductivity as claimed in claim 5, wherein the linear conductors are carbon fibers.

8. The method of manufacturing plate having through-plane conductivity as claimed in claim 5, wherein the metal material is a magnetic material selected from the group consisting of iron, cobalt, and nickel.

9. A fuel cell, comprising a first end plate; a first current collector arranged on the first end plate; a first conductive carbon paper arranged on the first current collector; a first bipolar plate arranged on the first conductive carbon paper; a membrane electrode arranged on the first bipolar plate; a second bipolar plate arranged on the membrane electrode; a second conductive carbon paper arranged on the second bipolar plate; a second current collector arranged on the second bipolar plate; and a second end plate arranged on the second current collector; wherein the first bipolar plate includes a first substrate and a plurality of linear conductors arranged in the first substrate and oriented by a magnetic field to extend in a direction perpendicular to a plane surface of the first substrate; and wherein the linear conductors are respectively coated with a metal material.

10. The fuel cell as claimed in claim 9, wherein the second bipolar plate includes a second substrate and a plurality of linear conductors arranged in the second substrate and oriented by a magnetic field to extend in a direction perpendicular to a plane surface of the second substrate; and wherein the linear conductors are respectively coated with a metal material.

11. The fuel cell as claimed in claim 10, wherein the first and the second bipolar plate are made of an epoxy resin material.

12. The fuel cell as claimed in claim 10, wherein the linear conductors are carbon fibers.

13. The fuel cell as claimed in claim 10, wherein the metal material is a magnetic material selected from the group consisting of iron, cobalt, and nickel.

14. The fuel cell as claimed in claim 10, wherein one of the first and the second substrate is provided on one surface facing toward the membrane electrode with a gas channel.
